(19) United States
(12) Patent Application Publication
(10) Pub. No.: US 2021/0256538 A1
(43) Pub. Date: Aug. 19, 2021

(54) Computer Methods and Systems for Dimensionality Reduction in Conjunction with Spectral Clustering of Financial or Other Data

(71) Applicant: Actimize LTD., Ra'anana (IL)

(72) Inventor: Danny BUTVINIK, Haifa (IL)

(21) Appl. No.: 16/791,693

(22) Filed: Feb. 14, 2020

(51) Int. Cl. G06Q 30/00; G06Q 40/02; G06F 16/28; G06N 20/00

(52) U.S. Cl. CPC G06Q 30/0185; G06N 20/00; G06F 16/285; G06Q 40/02

(57) ABSTRACT

Spectral clustering is used for clustering high dimensional data via sparse representation. The sparsity is increased by data pre-processing via weighted local principal component analysis. The approach is suitable for many applications, including financial applications such as anti-money laundering (AML). Other features are also provided.

### FIELD OF THE INVENTION

The presented disclosure relates to computer technology, and in particular to computer systems and techniques for dimensionality reduction in conjunction with spectral clustering of financial or other data. Some embodiments are suitable for using computer technology to combat money laundering.

### BACKGROUND OF THE DISCLOSURE

Financial institutions—including banks, brokerage firms and insurance companies—are required by law to monitor and report suspicious activities that may relate to money laundering and terrorist financing. The pertinent laws include Bank Secrecy Act and the USA PATRIOT Act in the United States, the Third EU Directive in Europe, Articles on the Criminalization of Money Laundering in Japan and others. As such, anti-money laundering (AML) compliance officers must create and maintain an effective transaction monitoring program to keep up with evolving regulations and control their AML program costs. Missteps could result in fines and reputational damage (e.g. negative impact to the organization's brand).

Financial institutions must have appropriate processes in place to identify unusual transactions and activity patterns. Since these events may not be suspicious in all cases, financial institutions must be able to analyze and determine if the activity, patterns or transactions are suspicious in nature with regard to, among other things, potential money laundering or terrorist financing.

Monitoring account activity and transactions flowing through a financial institution is critical to prevent money laundering. Suspicious activities, patterns and transactions must be detected and reported to authorities in accordance with corporate rules, local laws and/or national and international regulations. In most cases, these reports must be sent within specific timeframes, so institutions need strong and repeatable business processes, as well as enabling technology solutions, to meet these guidelines. Institutions also need to respond expeditiously to search requests from government authorities, sometimes within 48 hours.

Financial institutions use computers to store data on financial transactions, and to perform many types of transactions themselves, including Electronic Fund Transfers (EFT), credit card transactions, and other types. It is desirable to use the computers to detect and prevent money laundering and other financial crimes, as well as to perform other types of financial activity.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 illustrates a computer system storing financial data and suitable for financial data clustering according to some embodiments of the present invention.

FIGS. 2, 3, 4, 5, 6 illustrate computer processes related to data clustering.

FIG. 7 illustrates a computer process suitable for financial data analysis.

FIG. 8 illustrates a computer process for performing data segmentation.

FIGS. 9, 10, 11 illustrate computer processes suitable for financial data analysis.

### DETAILED DESCRIPTION OF SOME EMBODIMENTS

The invention is not limited to the specific or preferred embodiments discussed in this section, but is defined by the disclosure as a whole (including the drawings) and as presently recited in the appended claims. Various mechanical, compositional, structural, and operational changes may be made without departing from the scope of this description and the claims. In some instances, well known structures or techniques have not been shown or described in detail, as these are known to those of ordinary skill in the art.

Some embodiments of the present invention utilize machine learning for intelligent segmentation of data. Some embodiments are applicable to segmentation of financial data for various purposes including anti-money laundering (AML). Segmentation is performed by clustering financial data into appropriate clusters based on data similarity, e.g. based on similarity of financial activity of different accounts. For example, one segment may cluster together the accounts or customers engaging in suspicious activity possibly indicative of money laundering. Another segment may cluster together clean accounts, i.e. accounts or customers not engaging in suspicious activity. The clustering may use machine learning that can, advantageously, be frequently updated based on new account activity or other incoming data.

Many organizations do not utilize machine learning, but rather set up their segments once and do not update them often enough to reflect changes to their business, product types, or to their acceptable risk profile. These static segmentation strategies contribute to poor alert performance in the form of false positives.

By moving to a more dynamic assignment strategy, a data driven approach is used to create much tighter segments and reassign customers to segments as needed. Targeted models can be created and their thresholds can be tuned in a very specific manner for alert generation. In this approach, all the attributes of the customer or account, including their demographic information, behavior profile and other dynamic elements, are fed into an unsupervised machine learning model to draw inferences to create meaningful groupings. One suitable clustering technique is the K-means algorithm.

In anti-money laundering (AML), we are trying to achieve better detection of unusual behavior earlier and faster with minimum false positives (FPs), maximizing true positives (TPs) and without missing crime alerts. We also try to find different behavior group inside business segmentation, optimize rules thresholds per behavioral entity transaction profile. That would mean the ability to detect well separated clusters of financial data of significant size, which has high business value and low number of sparse features.

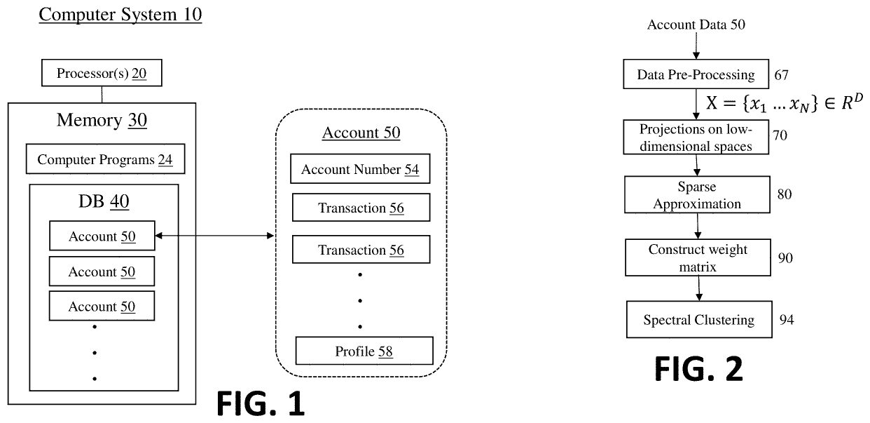

A major issue that needs to be resolved in order to achieve such goals using computer data processing is high dimensionality and sparsity of the financial data. FIG. 1 shows a financial institution's computer system 10 including one or more computer processors 20 executing computer programs 24 stored in memory 30. Memory 30 also contains an accounts database 40 with information on accounts 50. Each account item 50 identifies the corresponding account by some account ID (account number) 54, and stores data 56 on each transaction involving this account. Each transaction 56 is stored with its attributes including: transaction type, e.g. Electronic Funds Transfer (EFT), Automatic Teller Machine (ATM), credit card transaction, etc.; whether the account was a sender or a receiver in the transaction; the other account (receiver or sender) involved in the transaction; the transaction amount; relationships to other transactions; transaction date and time; and possibly other information. Also, account data item 50 may include profile information, e.g. the average, median, maximum, and minimum of transaction amounts of each type over different periods of time (e.g. over a month); relationship to other accounts; and possibly other information. Each attribute can be represented as one or more coordinates of a vector representing the account 50 or a transaction 56 or profile 58. The resulting vector may have high dimensionality. Even if the vector includes only the profile information, the dimensionality can be 40 or more. The high dimensionality may be at least partly due to using separate coordinates for each transaction type (ATM, or EFT, etc.). Also, due to separate coordinates for each transaction type, the vector may be sparse if the account 50 does not transact in all the transaction types. Sparsity means that the vector will have many zero coordinates (gaps). For example, if an account is transacting in “ATM withdrawal” but not in “credit card transaction” then the coordinates related to “credit card transaction” will have no value (missing value). A sparse vector is one that contains mostly zeros and few non-zero entries.

Due to high dimensionality, calculations are computationally expensive and require a lot of memory. With high dimensional data, the number of features can exceed the number of observations. Processing high dimensional data is challenging and sometimes impossible if the processing algorithm requires all the data to be in memory 30 or in some part of the memory.

Sparsity can be advantageous because the zeros are easier to process, but sparsity creates problems because sparse-data bias can cause misleading inferences about confounding, dimension proportion and bias, dimension relevancy issue, and can interact with other biases.

High dimensional and sparse data impede clustering by causing poor separation between clusters when applying the popular k-means algorithm. Possible problems include dimension proportion bias and dimension relevancy problem. The former means that it is difficult to evaluate proportions of dimensions and their possible bias. The latter means that when a dimension lacks information, it is impossible to evaluate the relevancy of this dimension. This implies that the resulting distance measure may have only a certain range of actual valid distances.

Preliminary research results indicate that spectral clustering of high dimensional data via sparse approximation segments a large high dimensional dataset of financial transactions more accurately and more precisely. This evidence leads to a more efficient and strict investigation in AML.

This allows achieving robust separation between clusters, reduction of false-positives (FPs) to avoid putting at risk legitimate entities, avoid conceiving abnormal behavior patterns, provide better irregularity detection, and create smarter peer-groupings for more accurate rules and alerts.

The high importance of clustering can be seen from its applications in many different areas of technology. Clustering is applied in financial domain building customer groups and in machine learning extracting concepts from data. Various clustering algorithms have been developed and new concepts as collaborative filtering have emerged. These algorithms are usually tightly coupled to a given problem range. Not much evaluation has been done on comparing different approaches on the applicability of their solutions, especially not for high dimensional and sparse data. Whether algorithms can be compared at all is of course questionable due to the differences between the algorithms. Due to the importance of this huge and emerging market there should be put an emphasis on the comparability of these approaches. The difficulty arises because of the incompleteness of data. This leads directly to the actual problem of clustering high dimensional sparse data and the evaluation of the results. The problem has different aspects. First, with high dimensional sparse data it is uncertain whether the data reflects the actual distribution or not. There is a chance that the data is strongly biased, especially for user content. This is due to the fact that users tend to comment on items either if they highly like or highly dislike the content, but not in between. Another cause of errors is the choice of approaches or algorithms. It is difficult to find a suitable approach with only a small subset of the data. Whether a choice was good or bad is hard to determine.

There is a wide range of possible clustering approaches. Some are more widely used, some less. Some emphasize certain particularities and assume a certain distribution on the data. Some tend to smooth outliers better. So taking first steps in clustering given a certain problem is difficult. The sheer possibilities are concerning. And it is even harder to know whether an approach performs better or worse for high dimensional and sparse data as far more assumptions have to be made than in common datasets, which can result in inaccuracies based on incorrect assumptions.

Spectral clustering is not entirely distinguishable from other clustering approaches and is related to singular value decomposition (SVD) and kernel principal component analysis (KPCA). While SVD calculates singular values, spectral clustering algorithms use eigenvectors and eigenvalues hence requiring a square matrix (usually a distance matrix). The similarity to KPCA refers to the used kernel which transforms the data with a given kernel method (linear or non-linear), allowing further analysis and hopefully easier distinction between clusters. The work on this topic is immense covering many different research fields.

Clustering high dimensional data has been a challenging problem in data mining and machining learning. Spectral clustering via sparse representation has been proposed for clustering high dimensional data. See for example Xiadong Feng, “Robust Spectral Clustering via Sparse Representation”, IntechOpen 2018, http://dx.doi.org/10.5772/intechopen.76586, incorporated herein by reference. A critical step in spectral clustering is to effectively construct a weight matrix by assessing the proximity between each pair of objects. While sparse representation has proved its effectiveness for compressing high dimensional signals, existing spectral clustering algorithms based on sparse representation use individual sparse coefficients directly. Exploiting complete sparse representation vectors, however, is expected to reflect more truthful similarity among data objects according to the present disclosure, since more contextual information is being considered. Without being bound by theory, it is believed that sparse representation vectors corresponding to two similar objects are expected to be similar, while those of two dissimilar objects are dissimilar. In particular, two weight matrix constructions are proposed for spectral clustering based on the similarity of the sparse representation vectors. Experimental results on several real-world, high dimensional datasets demonstrate that spectral clustering based on the proposed weight matrices outperforms existing spectral clustering algorithms, which use sparse coefficients directly.

According to some embodiments of the present invention, there is provided a computer implemented method and system for optimal spectral clustering of high dimensional and sparse data.

Some embodiments provide a practical approach for evaluating clustering algorithms on different datasets to examine their behavior on high dimensional and sparse datasets. High dimensionality and sparsity pose high demands on the algorithms due to missing values and computational requirements. It has already been proven that some algorithms perform significantly worse under high dimensional and sparse data. Approaches to circumvent these difficulties are analyzed and addressed herein. Distance matrices and recommender systems are examined to either reduce the complexity or to impute missing data. A special focus is then put on the similarity between clustering solutions with the goal of finding a similar behavior. The emphasis is on getting flexible results instead of significantly tweaking certain algorithms, as the problem cannot be readily reduced to the mathematical performance due to missing values. Generally, good and flexible results have been achieved with a combination of content-based-filtering and hierarchical clustering methods or the affinity propagation algorithm. Kernel-based clustering results differed much from other methods and were sensitive to changes on the input data.

As an important task in data mining, cluster analysis aims at partitioning data objects into several meaningful subsets, called clusters, such that data objects are similar to those in the same cluster and dissimilar to those in different clusters. With advances in data base technology and real-world need of informed decisions, datasets to be analyzed are getting bigger, with many more data records and attributes. Examples of high dimensional datasets include document data, financial data, financial timeseries data, and so on. Due to the “curse of dimensionality”, clustering high dimensional data has been a challenging task, and therefore, attracts much attention in datamining and related research domains.

Spectral clustering with sparse representation has been found to be effective for clustering high dimensional, sparse data. Spectral clustering is based on the spectral graph model. It is powerful and stable for high dimensional data clustering, and is superior to traditional clustering algorithms such as K-means, due to its deterministic and polynomial-time solution. Nonetheless, the effectiveness of spectral clustering mainly depends on the input weights between each pair of data objects. Thus, it is vital to construct a weight matrix that faithfully reflects the similarity information among objects. Traditional simple weight construction, such as E-ball neighborhood, k-nearest neighbors, inverse Euclidean distance and Gaussian RBF (Radial Bias Function), is based on the Euclidean distance in the original data space, thus not suitable for high dimensional data due to the “curse of dimensionality” in the original object space. However, sparse representation, coming from compressed sensing, proves to be an extremely powerful tool for acquiring, representing, and compressing high dimensional data by representing each object approximately as a sparse linear combination of other objects. Finding sparse representations transforms the objects space into a new sparse space.

Since sparse coefficients represent the contribution of each object to construction of other objects, existing spectral clustering methods based on sparse representation use these sparse coefficients directly to build the weight matrix. Using the isolated coefficients individually warrants that only local information is utilized. However, exploiting more contextual information from the whole coefficient vectors promises better assessment of similarity among data objects. Without being bound by theory, it is understood that the sparse representation vectors corresponding to two similar objects should be similar, since they can be reconstructed in a similar fashion using other data objects.

In some embodiments, sparse approximation is used to represent the data to be clustered, so that each data point could be represented as a sparse linear combination of other data points. The sparsity of this representation is increased by preprocessing the data using projections onto linear low-dimensional spaces.

Some embodiments of the present invention exploit information from sparse representation vectors to construct weight matrices (step 90 in FIG. 2) for spectral clustering of high dimensional data. For example, some embodiments cluster the accounts 50 or the account owners based on the accounts' attributes. Some clusters can then be marked as suspicious accounts based on other information; other clusters can be marked as “clean” accounts.

In some embodiments, at step 67, the computer system 10 receives account data arranged as vectors of some dimension D. For example, each vector may correspond to an account 50 or a transaction 56 or profile 58 or an entity. An entity can be, for example, the financial institution's customer having one or more accounts 50, and/or can be an entity transacting with the financial institution's customer or account. At step 67, the data are pre-processed (flattened, normalized). The pre-processed data are shown as a set:

X={x₁. . . x_{N}}∈R^{D} (Eq.01)

In some embodiments, pre-processing step 67 is conventional.

Then (step 70) the dataset X, or one or more subsets of X, are projected onto one or more linear spaces of dimension(s) d lower than D. In some embodiments, this is done by local weighted principal component analysis (local WPCA). The low dimension d may or may not be the same for all points x₁. In an example, D is at least 40, and d is at most 10. In some embodiments, d is less than the dimension of the vector space <X> spanned by the set X.

In some embodiments of step 70, for each point xᵢ in X, each subset is a set S(x) of K nearest neighbors of x, where K is a predefined integer, possibly the same or different for different points x.

Let yᵢ denote the projection of x₁.

Then (step 80), each d-dimensional data object (data point) yᵢ output by step 70 is represented (possibly approximated) by a sparse linear combination of other data objects in the set Y:

yᵢ=Σ_{j≠i}αᵢⱼyⱼ (Eq.02)

The linear coefficients αᵢⱼ in the sparse approximation can be used, at step 90, to define similarity between the corresponding data objects and construct the weight matrix.

Importantly, the projection(s) at step 70 tend to increase the sparsity (the number of zeros) of coefficients αᵢ in the linear representations at step 80.

In some embodiments, the coefficients αᵢⱼ are determined in solving an optimization problem with an error function that depends on errors in obtaining yᵢ from xᵢ. In some embodiments, the errors are used to weigh the error function's terms in determining the αᵢⱼ coefficients so that if an error is high for some yᵢ, then the corresponding term in the error function is given less weight (because the corresponding xᵢ is more likely to be an outlier).

At step 90, different similarity measures can be used to construct the similarity (weight) matrix. For example, the similarity matrix can be constructed based on the consistency of directions, or based on the consistency of magnitudes.

Then (step 94) spectral clustering is performed on the weight matrix. Then different clusters can be tagged as suspicious or clean based on other information.

Some embodiments of the present disclosure recognize the value of WPCA at step 70 and of utilizing contextual information for assessing the similarity between data objects at step 80 and subsequent steps. More specifically, in the context of similarity matrix construction for spectral clustering, it is submitted that the sparse representation vectors, compared with individual sparse coefficients, contain more details and stronger evidence of similarity between data objects. In addition, two exemplary ways are proposed to form the similarity matrix utilizing sparse representation vectors. Considering the direction of coefficient vectors, we examine the consistency of the signs for coefficients in the sparse representation vectors. Considering the magnitude of coefficient vectors, the similarity of the sparse representation vectors can be achieved using the cosine measure. Finally, the proposed approaches are validated by comparing them with existing methods.

Techniques for high dimensional data: There are many techniques to deal with high dimensional data. To make the clustering more robust and resilient to new incoming data and stable in the presence of outliers, the dimensionality can be reduced by, for example, WPCA (step 70).

Also, some embodiments utilize nonnegative matrix factorization (NMF) which is a powerful dimensionality reduction technique. The basic idea is to approximate a non-negative matrix by the product of two non-negative, low-rank factor matrices. Focus on NMF can be through assessing consistency between the original matrix and the approximate matrix, using Kullback-Leibler divergence, Euclidean distance, earth's mover distance, or Manhattan distance.

Sparse representation: A sparse representation of data is a representation in which few parameters or coefficients are not zero, and many are (strictly) zero. Sparse Approximation theory deals with sparse solutions for systems of linear equations. Techniques for finding these solutions and exploiting them in applications have found wide use in machine learning.

Sparse approximations have a wide range of practical applications. Vectors are often used to represent large amounts of data which can be difficult to store or transmit. By using a sparse approximation, the amount of space needed to store the vector can be reduced to a fraction of what was conventionally needed. Sparse approximations can also be used to analyze data by showing how column vectors in a given basis come together to produce the data.

There are many different methods used to solve sparse approximation problems but by far the two most common methods in use are the Least Absolute Shrinkage And Selection Operator (LASSO) and orthogonal matching pursuit. LASSO replaces the sparse approximation problem by a convex problem. One of the motivations for change to a convex problem is there are algorithms which can effectively find solutions. Orthogonal matching pursuit is a “greedy” method for solving the sparse approximation problem. This method is very straight forward as the approximation is generated by going through an iteration process. During each iteration the column vectors which most closely resemble the required vectors are chosen. These vectors are then used to build the solution.

By utilizing least absolute shrinkage and selection operator (LASSO) the below equation (Eq.30) enables the process of spectral clustering of high dimensional data with sparse representation. In representing sparse data via LASSO, an assumption is made in manifold learning that (Eq.25) can be used. That means the known approach to spectral clustering of high dimensional data with sparse representation utilizes well known nonlinear approach to dimensionality reduction which is Local Linear Embedding (LLE). But that approach suffers from numerous issues and problems:
There are known difficulties with topological ‘holes’ of high dimensional data. That means, the separation of oval shapes of data will be problematic, non-precise and diffusive.
Sensitive to noise: financial high dimensional sparse data always carry noise
Inability to deal with novel data. That means new arriving data will fit poorly into clusters
Inevitable ill-condition of eigenvectors of the constructer similarity matrix further on due to the specificity of sparse weighted matrix

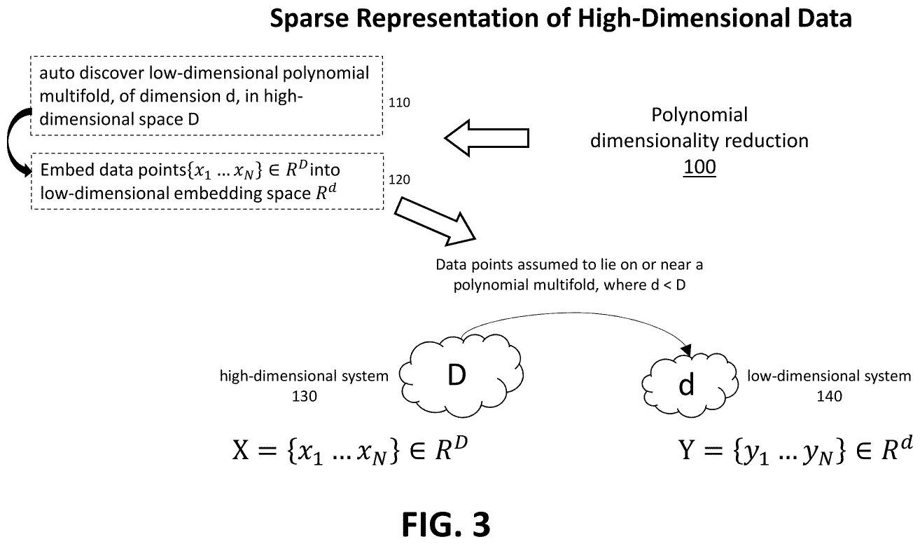

FIG. 3 illustrates a conventional LLE process 100 to reduce data dimensionality. The process uses a polynomial dimensionality reduction. The input is:

X={x₁. . . x_{N}}∈R^{D} (Eq.03)

of some dimension D, in a D-dimensional system 130. At step 110, a suitable low dimensional polynomial multifold (manifold) is fitted to the data X, of a dimension d<<D. In an example, D may be 40 or 80 or greater, and d may be 10 or smaller. At step 120, the data X are projected onto a d-dimensional system 140, possibly the d-dimensional manifold, possibly a linear d-dimensional space related to (e.g. tangent to) the d-dimensional manifold. The projected data points are shown as

Y={y₁. . . y_{N}}∈R^{d} (Eq.04)

The system of FIG. 3 suffers disadvantages such as described above, including instability in the presence of outliers.

Some embodiments, such as described below in the section “Unfluctuating Sparse Representation”, solve the above problems, at step 70 (FIG. 2) by representing sparse data in a more efficient way than in standard manifold learning (LLE). In particular, some embodiments provide:
More inefficient representation for sparse data (better use of computational resources, e.g. memory)
Ability to deal with noisy data, as well as with outliers
Ability to process new data efficiently
Ability to detect topological ‘holes’ in the data and separate them.

Thus, some embodiments use the following principles:
1. Smart unfluctuating sparse representation of the high dimensional data.
2. Implementation of the known modern approach of spectral clustering of high dimensional data with sparse representation.
3. Unique application of the spectral clustering of high dimensional data with sparse representation on unique high dimensional sparse data for anti-money laundering investigations.

### Unfluctuating Sparse Representation (Projection Step 70)

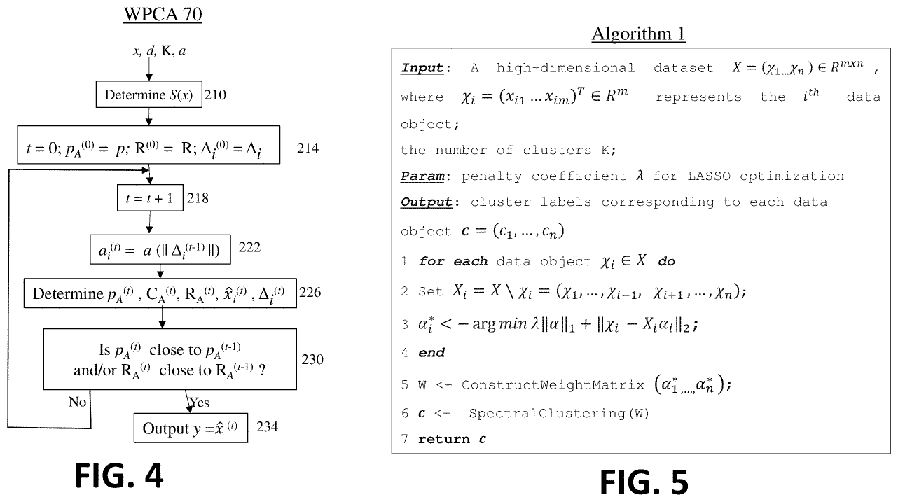

FIG. 4 illustrates one embodiment of step 70 performed for a single point x in the set X={x₁ . . . x_{N}}∈R^{D}. First (step 210), computer system 10 finds a set S(x) of K nearest neighbors of x, where K is a predefined integer greater than 1. The term “nearest” can be defined using any suitable metric, for example, the Euclidean metric. The point x is assumed to be in the set S(x). Without loss of generality, we denote the points of S(x) as:

S(x)={x₁. . . x_{K}} (Eq.05)

The indices (subscripts) 1 . . . K in this expression are not necessarily the same as in the input data X in expression (Eq.03) above. For example, the point xᵢ of the set S(x) may be x₁₀ in the set X.

The points of the set S(x) can be represented as column vectors in a matrix M_{S×D} with S=S(x) rows and D columns:

M_{S×D}=[x₁. . . x_{K}] (Eq.06)

If a point xᵢ of the set S=S(x) lies on a manifold fitted to the points of S, then the point xᵢ can be approximated by a point vᵢ on a locally linear patch, i.e. a linear subspace or some dimension d less than D, because the manifold can be locally approximated by the linear patch. Each point vᵢ can be a normal projection of xᵢ on the linear subspace. The projection can be represented as:

vᵢ=R^{T}(xᵢ−p) (Eq.07)

where p is a D-dimensional shift vector representing the average of the points of S, and R^{T} is a (d×D) matrix which is a transpose of a (D×d) matrix R, where R can be represented as:

R=[R₁, . . . R_{d}] (Eq.08)

for some R₁, . . . R_{d}.

The matrix R is a rotation matrix: Rᵢ^{T}Rⱼ=δᵢⱼ, where δᵢⱼ is defined as 1 if i=j, and 0 if i is not equal to j. In other words, the vectors Rᵢ are an orthonormal system in R^{D}. Therefore,

R×R^{T}=I_{D} (Eq.09)

where I_{D} is a D×D identity matrix.

In non-weighted PCA, the vectors Rᵢ can be eigenvectors of the covariance matrix C of the vectors of the set S: the covariance matrix element C(i,j) is a statistical covariance of the normalized ith and jth coordinates of the vectors of the set S:

$$C = \frac{1}{K} {\sum }_{i = 1}^{K} ( {x}_{i} - p ) {( {x}_{i} - p )}^{T} \qquad ( Eq .10 )$$

In this expression, each term (xᵢ−p) is a column vector, i.e. D×1 matrix. Each term (xᵢ−p)(xᵢ−p)^{T} is a D×D matrix.

In the weighted PCA according to some embodiments of the present disclosure, the vectors Rᵢ can be eigenvectors of the normalized, zero-mean, weighted covariance matrix C_{A} described below.

Equation (Eq.07) represents rotating the vector xᵢ and then discarding (D-d) of the xᵢ coordinates. Assuming that the discarded coordinates are set to zero, and the vector vᵢ is rotated back, the resulting (reconstructed) R^{D} vector, denoted by \hat{x}ᵢ (or sometimes by yᵢ), is:

$${\hat{x}}_{i} = p + R {v}_{i} = p + R {R}^{T} ( {x}_{i} - p ) \qquad ( Eq .11 )$$

The error term Δᵢ of discarding the D−d coordinates is:

$${Δ}_{i} = {x}_{i} - {\hat{x}}_{i} = {x}_{i} - p - R {v}_{i} \qquad ( Eq .12 )$$

If the PCA is unweighted (i.e. all the weights are equal to 1), then the total error is the sum of the norms of the error terms Δᵢ. Assuming the Euclidean norm l₂, the total error is:

$${E}_{PCA} = {\sum }_{i = 1}^{K} {‖ {Δ}_{i} ‖}^{2} = {‖ M - P - RV ‖}_{F} \qquad ( Eq .13 )$$

where:
∥ . . . ∥_{F} is the Frobenius norm;
M is given by equation (Eq.06);
P is a column vector p repeated K times:
   P=[p . . . p]
V is a K-column matrix whose ith column is vᵢ:
   V=[v₁ . . . v_{K}]

However, PCA is not as robust against outliers as other LS estimators (least square estimators), so weighted PCA has been proposed as an alternative. See Isao Higuchi et al, “Robust Principal Component Analysis with Adaptive Selection for Tuning Parameters”, Journal of Machine Learning Research 5 (2004) 453-471, incorporated herein by reference. A weighted PCA method is also described in Ruixin Guo et al, “Spatially Weighted Principal Component Analysis for Imaging Classification”, J Comput Graph Stat. 2015 January; 24(1): 274-296. doi:10.1080/10618600.2014.912135, incorporated herein by reference.

Some embodiments of the present disclosure perform weighted PCA with some set A of non-negative weights:

A={a₁. . . a_{K}} (Eq.14)

Instead of minimizing the E_{PCA} value of equation (Eq.13), minimized is the weighted PCA value:

E_{PCA}=Σᵢ₌₁^{K}(aᵢ·∥Δᵢ∥²) (Eq.15)

The values Δᵢ are as in (Eq.12), except that the p vector is replaced by p_{A} defined as:

$${p}_{A} = \frac{{\sum }_{i = 1}^{K} {a}_{i} {x}_{i}}{{\sum }_{i = 1}^{K} {a}_{i}} \qquad ( Eq .16 )$$

The LS estimator consists of orthonormal eigenvectors R₁ . . . R_{d} which are eigenvectors of the weighted covariance matrix C_{A}. Specifically:

$${C}_{A} = \frac{1}{K} {\sum }_{i = 1}^{K} {a}_{i} ( {x}_{i} - {p}_{A} ) {( {x}_{i} - {p}_{A} )}^{T} \qquad ( Eq .17 )$$

where each aᵢ is a non-negative weight determined as described below. C_{A} is a D×D matrix.

The challenge is to determine the weights aᵢ that would be small when the corresponding xᵢ is an outlier. For example, a weight aᵢ could be made small if the corresponding ∥Δᵢ∥ is large. But Δᵢ depends on p_{A} and R, which depend on the weights Δᵢ and this cyclic dependency creates a challenge in determining the weights A.

In some embodiments of the disclosure, the method is performed iteratively. In each iteration, the weight aᵢ is determined based on the value Δᵢ in the previous iteration. In some embodiments, the weight aᵢ is computed as a value of a predefined function a(⋅) on the value Δᵢ in the previous iteration. In some embodiments, the function a(⋅) is a decreasing function (possibly, but not necessarily, strictly decreasing) on non-negative real numbers, and is computed on the norm ∥Δᵢ∥:

a₁=a(∥Δᵢ∥) (Eq.18)

In some embodiments:

a(x)=1/x

In other embodiments, a(x) is linear, strictly decreasing on a finite interval of non-negative real numbers, and is zero outside of that interval.

In some embodiments the weight values aᵢ are normalized, i.e. replaced by their normalized counterparts aᵢ*:

$${a}_{i}^{*} = \frac{{a}_{i}}{{\sum }_{j = 1}^{K} {a}_{j}} \qquad ( Eq .19 )$$

FIG. 4 shows an exemplary WPCA process 70 for a single point x in the set X. The process is repeated for each point x in X. We use t as an iteration index: t=0, 1, 2, . . . . The invention is not limited to any particular iteration indexing. The values aᵢ, p_{A}, Δ, R, etc. related to iteration t are shown with superscript (t): aᵢ^{(t)}, p_{A}^{(t)}, Δ^{(t)}, R^{(t)}, etc.

At step 210, the process receives the input values xᵢ d, K, and a definition of function a(⋅), and determines the set S(x) as described above in connection with (Eq.05). In some embodiments, K>d. In some embodiments, d is smaller than the dimension of the vector space <S> spanned by the set S. These limitations on d are exemplary and may or may not hold for any given point x.

At step 214, the process is initialized as in standard (non-weighed) PCA, which is equivalent to the weighted PCA with all the weights aᵢ=1. In particular, t is set to zero. Further, p_{A}⁽⁰⁾ is computed as the average of members of S(x), i.e. as in (Eq.16) assuming that all the weights aᵢ=1. The matrix R⁽⁰⁾=R is computed as the first d eigenvectors (corresponding to the d largest eigenvalues in the list of decreasing eigenvalues with each eigenvalue repeated according to its multiplicity), as in non-weighted PCA. Δᵢ⁽⁰⁾ is computed as in (Eq.12). Step 214 can be considered as the 0^{th} iteration (t=0).

At step 218, the next iteration begins with incrementing the iteration index t. At step 222, the new error values aᵢ^{(t)} are computed as in equation (Eq.18) from the Δᵢ^{(t-1)} values in the previous iteration. The aᵢ^{(t)} values can then be normalized per (Eq.19). At step 226, the values p_{A}^{(t)}, C_{A}^{(t)}, R_{A}^{(t)}, \hat{x}ᵢ^{(t)}, Δᵢ^{(t)} are determined as follow.

The value p_{A}^{(t)} is determined as in equation (Eq.16), using the weights determined at step 222.

The covariance matrix C_{A}^{(t)} is determined as in equation (Eq.17).

The matrix R_{A}^{(t)} is determined as the d mutually orthogonal, orthonormal eigenvectors of C_{A}^{(t)} corresponding to the d largest eigenvalues, applying a non-weighted PCA algorithm to C_{A}^{(t)} instead of C.

The values \hat{x}ᵢ^{(t)} are determined similarly to equation (Eq.11):

$${\hat{x}}_{i} = {p}_{A} + {R}_{A} {v}_{i} = {p}_{A} + {R}_{A} {R}_{A}^{T} ( {a}_{i} {x}_{i} - {p}_{A} ) \qquad ( Eq .20 )$$

The Δᵢ^{(t)} values are determined similarly to equations (Eq.12):

$${Δ}_{i}^{( t )} = {a}_{i} {x}_{i} - {\hat{x}}_{i} = {a}_{i} {x}_{i} - {p}_{A} - {R}_{A} {v}_{i} \qquad ( Eq .21 )$$

At step 230, a test is made to determine whether additional iterations are needed. This can be any suitable test. For example, the iteration loop may be terminated if the value p_{A}^{(t)} is closer to p_{A}^{(t-1)} than a predefined threshold Th1 under some metric (e.g. Euclidean metric), and/or R_{A}^{(t)} closer to R_{A}^{(t-1)} than a predefined threshold Th2 under some metric (e.g. Frobenius norm):

∥p_{A}^{(t)}−p_{A}^{(t-1)}∥<Th1 (Eq.22)

∥R_{A}^{(t)}−R_{A}^{(t-1)}∥F<Th2 (Eq.23)

The maximum number of iterations can also be predefined, so the loop may be terminated when the maximum predefined t value is reached.

If the test of step 230 is successful (i.e. no new iterations are needed), then at step 234 the output value y is set to the value \hat{x}^{(t)}, i.e. yᵢ is set to the value \hat{x}ᵢ^{(t)} where i is such that xᵢ=x.

If the test 230 fails, the next iteration is performed starting step 218.

In some embodiments, if the test 230 fails with respect to p_{A}^{(t)} and/or R_{A}^{(t)}, i.e. inequalities (Eq.22) and (Eq.23) do not hold, but some predefined, maximum number of iterations have been reached, the loop is restarted at step 210 with a different set S(x), and/or a different function a, and/or a larger value of d, and/or a smaller value of K. The number of times to restart the loop at step 210 can be limited to a predefined value. If the loops keep failing at step 230, the method may proceed to step 234 or may terminate with an error message.

In some embodiments, the process of FIG. 4 is performed for each point x in the set X. The outputs y at step 234 form the set Y of (Eq.04).

Clearly, each point xᵢ of the set X belongs to one or more sets S(x). For each set S(x), at the corresponding instance of step 234 (FIG. 4), the point xᵢ is associated with a (possibly normalized) weight aᵢ (see step 222). Let us denote this normalized weight aᵢ as aᵢ*(xᵢ, x). The smaller the normalized weight aᵢ*, the greater the reconstruction error, and hence the likelier it is that xᵢ is an outlier.

For each xᵢ in X, a score sᵢ can be determined as follows:

sᵢ=Σ_{x∈X}aᵢ*(xᵢ,x) (Eq.24)

For each point xᵢ in X, the smaller its score sᵢ, the likelier it is that the point xᵢ is an outlier. The scores sᵢ can therefore be used to identify outliers if needed in step 80 or any other processing.

### Sparse Approximation (Step 80)

Change in notation: Below, the following notation is used:

χᵢ=yᵢ

m=D

n=N.

Also, the symbol X will be used for the set of vectors χᵢ=yᵢ rather than xᵢ.

Turning now to step 80, suppose we are given a sufficient high dimensional training dataset X=(χ₁ . . . Xₙ)∈R^{m×n}, where χᵢ=(xᵢ₁ xᵢₘ)^{T}∈R^{m} is a column vector representing the ith object. Research on manifold learning has shown that any test data y lies on a lower-dimensional manifold, which can be approximately represented by a linear combination of the training data

y=α₁ ₁+ . . . +αₙχₙ=χα∈Rⁿ (Eq.25)

where α=(α₁ . . . aₙ)^{T} represents the vector of coefficients that need to be determined.

Typically, the number of training objects is much larger than the number of attributes, that is, n>>m. In this case, (Eq.25) can be undetermined, and its solution is possibly not unique. But, if we add the constraint that the best solution of α in (Eq.25) should be as sparse as possible, which means that the number of non-zero elements is minimized, then the solution may be unique. Such a sparse representation can be obtained by solving the following optimization problem:

α*=arg min ∥α∥₀, subject to y=Xα (Eq.26)

where ∥⋅∥₀ denotes the l₀ norm of a vector, i.e. the number of non-zero coordinates of the vector.

In many situations the noise level ε is not known. Then LASSO can be used to recover the sparse solution from the following optimization:

α*=arg min λ∥α∥₁+∥y−Xα∥₂, (Eq.27)

where λ is a scalar regularization parameter of the LASSO penalty, which directly determines how sparse a will be and balances the tradeoff between reconstruction error and sparsity.

Sparse representation for clustering: Given a high dimensional dataset X=(χ₁ . . . χₙ)∈R_{m×n}, where λᵢ=(xᵢ₁ . . . xᵢₘ)^{T}∈R^{m} represents the ith data object, equation (Eq.27) can be used, for y=χᵢ, to represent each object χᵢ as a linear combination of other objects.

In a change of notation, let αᵢ denote a vector of the a coefficients in (Eq.27) for y=χᵢ. Then the coefficient vector αᵢ can be calculated by solving the following LASSO optimization:

αᵢ*=arg min λ∥αᵢ∥₁+∥χᵢ−Xᵢαᵢ∥₂, (Eq.28)

where:
Xᵢ=X\χᵢ=(χ₁, . . . , χᵢ₋₁, χᵢ₊₁, . . . , χₙ)
   consists of all data objects except for χᵢ, and the optimal solution

αᵢ*=(αᵢ₁, . . . ,α_{i,i-1},0,α_{i,i+1}, . . . ,αᵢₙ)^{T} (Eq.29)

consists of sparse coefficients corresponding to each data object in Xᵢ, ∀i=1, 2, . . . n.

In another change of notation, let us use αᵢ* to denote the vector in (Eq.29) augmented with a zero coordinate αᵢᵢ:

αᵢ*=(αᵢ₁, . . . ,α_{i,i-1},0,α_{i,i+1}, . . . ,αᵢₙ)^{T} (Eq.30)

This augmented vector will be called the sparse representation vector of data object χᵢ, ∀i=1, 2, . . . n.

The formal definition for a sparse coefficient would be as follows: the j^{th} element αᵢⱼ in the sparse representation vector of data object χᵢ is the sparse coefficient of data object χⱼ for data object χᵢ, ∀i=1, 2, . . . n.

In some embodiments, the optimization problem of (Eq.28) is modified to use the scores sᵢ (Eq.24). In particular, in an error function for (Eq.28), a lower weight can be given to the data objects for which the score sᵢ is lower (i.e. the data objects possibly corresponding to outliers). For example, in some embodiments:

α*=arg min λ∥α∥₁+Φₑᵣᵣ(α) (Eq.31)

i.e. the error function is:

λ∥αλ₁+Φₑᵣᵣ(α)

where:

α is an m×n matrix: α=(α₁, . . . , αₙ); and

Φₑᵣᵣ(α) is some function that couples each score sᵢ with a χᵢ term, such that Φₑᵣᵣ(α) is an increasing function in each sᵢ. For example:

Φₑᵣᵣ(α)=Σᵢ₌₁^{N}sᵢ·∥χᵢ−Σ_{j≠i}αᵢⱼχⱼ∥² (Eq.32)

The coefficients αᵢᵢ are zero, as in (Eq.30).

In case of (Eq.32), the (Eq.31) terms for different i values can be separated, so the optimization problem is reduced to separate optimization problems:

αᵢ*=arg min λ∥αᵢ∥₁+sᵢ·∥χᵢ−Σ_{j≠i}αᵢⱼχⱼ∥²,i=1,2, . . . n

In other embodiments:

Φₑᵣᵣ(α)=Σᵢ₌₁^{N}sᵢ·∥χᵢ−Σ_{χ}_{ⱼ}_{∈S′(χ}_{ᵢ}⁾αᵢⱼχⱼ∥²

where:
S′(χᵢ) is the set of K nearest neighbors of the point χᵢ, not including the point χᵢ itself. K can be any positive integer, and may or may not be the same as in FIG. 4;
αᵢⱼ are as in (Eq.30), and are indeterminates for χⱼ∈S′(χᵢ), and are zero otherwise.

In this case, the (Eq.31) problem is reduced to the following optimization problems:

αᵢ*=arg min λ∥αᵢ∥₁+sᵢ·∥χᵢ−Σ_{χ}_{ⱼ}_{∈S′(χ}_{ᵢ}₎αᵢⱼχⱼ∥²,i=1,2, . . . n

Each sparse coefficient αᵢⱼ represents contribution of data object χⱼ to the reconstruction of data object χᵢ. So, the sparse representation vector of χᵢ is a vector of contribution weights from all data objects to the reconstruction of χᵢ. By definition, since αᵢᵢ=0 ∀i=1, 2, . . . n, there is no contribution from a data object to itself. Of note, the sparse coefficients do not necessarily have the reciprocity property: αᵢⱼ and αᵢⱼ are not necessarily equal, implying different levels of reconstruction contribution between a pair of data objects.

### Construct Weight Matrix (Step 90)

Existing weight matrix (i.e. similarity matrix) construction methods via sparse representation are based on the assumption that the sparse coefficients reflect the closeness or similarity between data objects. There are several similarity measures. The sparsity induced similarity (SIS) measure is computed as follows:

$$S I {S}_{i j} = \frac{+ {\tilde{α}}_{j}}{2} ,$$

where

$$= \frac{max ( {α}_{ij} , 0 )}{{\sum }_{k = 1}^{n} max ( {α}_{i k} , 0 )} .$$

The main idea is to ignore negative contributions and symmetrize sparse coefficients for each pair of data objects.

Sparse representation vectors for spectral clustering: Some embodiments use the following methods: (1) at step 80, solving l₁ optimization of sparse representation to obtain the coefficients of each object; (2) at step 90, constructing weight matrix between objects using complete solution coefficients of sparse representation; (3) at step 94, exploiting the spectral clustering algorithm with the weight matrix to find the partitioning results.

Some embodiments define proximity based on cosine similarity of coefficient vector construction approach. Consider αᵢ and αⱼ, the sparse representation vectors of data objects χᵢ and χⱼ. If χᵢ and ⱼ are similar, then we expect their sparse representation vectors aₜ and aᵢ to be similar. Since cosine measure is a commonly used as a similarity measure between two vectors, the approach to construct weight matrix is considered to be based on the cosine similarity between the sparse representation vectors. The weight between object χᵢ and χⱼ is defined as follows:

$${COS}_{ij} = max \{ 0 , \frac{{α}_{i} * {α}_{j}}{{‖ {α}_{i} ‖}_{2} * {‖ {α}_{j} ‖}_{2}} \}$$

FIG. 5 (“Algorithm 1”) describes a general procedure for spectral clustering of high dimensional data, using sparse representation. The basic idea is to extract coefficients of sparse representation (lines: 1-4), construct a weight matrix using the coefficients (line: 5), and feed the weight matrix into a spectral clustering algorithm (line: 6) to find the best partitioning efficiently.

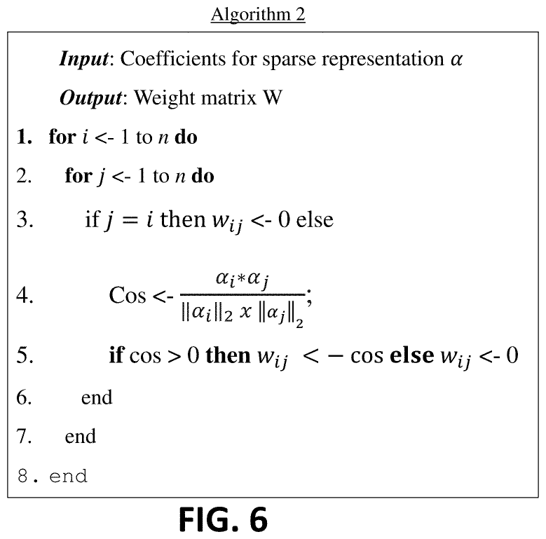

FIG. 6 (Algorithm 2) describes a procedure to construct the weight matrix (FIG. 5, line 5) according to the cosine similarity of the sparse coefficients between each pair of items. The computation complexity for calculating the cosine similarity of two vectors of length n is O(n), and there are O(n²) pairs of data objects whose cosine similarity needs to be computed. Thus, the complexity for cosine similarity based weight matrix construction is O(n³). In FIG. 5, line 6, after constructing the weight matrix W, the classic spectral clustering algorithm can be applied to discover the cluster structure of high dimensional data.

Some characteristics of some embodiments are: (1) Weight matrix is constructed by transforming the high dimensional data space into another space via sparse representation, which is expected to have better performance attributed to the superiority of high dimensional data. (2) Graph construction based on similarity of coefficient vector can simultaneously complete both the graph adjacency and weight matrix, while traditional graph constructions complete the two tasks separately, which are interrelated and should not be separated. (3) The proposed approach considers the complete information from the coefficients of the whole set of objects to calculate one element in the weight matrix.

Embodiments of the present invention may include receiving a business segment of financial data. The suggested approach performs accurate and robust clustering while minimizing then number of FPs, by providing precise irregularity detection with smarter peer groupings for more accurate rules and alerts.

### Practical Implementation—Introduction

To monitor and mitigate money laundering risk, identification of suspicious activities by the bank's customers (or entities) is the first step. Currently, Applicant Nice Actimize offers its clients approximately 250 rules that can be used to identify suspicious activities. These rules are implemented in Nice Actimize's anti-money laundering solution, “Suspicious Activity Monitoring” (SAM) Version 9, which is deployed at a client's on-premise production environment and integrated with the client's internal systems to access data inputs.

Typically, applying a rule on all the entities of a bank is neither feasible nor relevant. So, segmenting the entities on the basis of business knowledge (i.e. static attributes like product/account-type, entity-type etc.) and then applying a rule applicable for the particular business segment provides a more targeted approach to monitoring. However, just simple segmentation does not necessarily ensure the best solution. Hence, after creating segments, an optimization process is needed to achieve the overall goal of reducing the number of false positives while maintaining high coverage. This goal can be achieved by combining a Segmentation process with a Tuning/Optimization process which allows targeted application of rules and provides an efficient approach to fine tuning the rules thresholds based on the new segments to minimize workload by reducing false positives, while providing more accurate alerts.

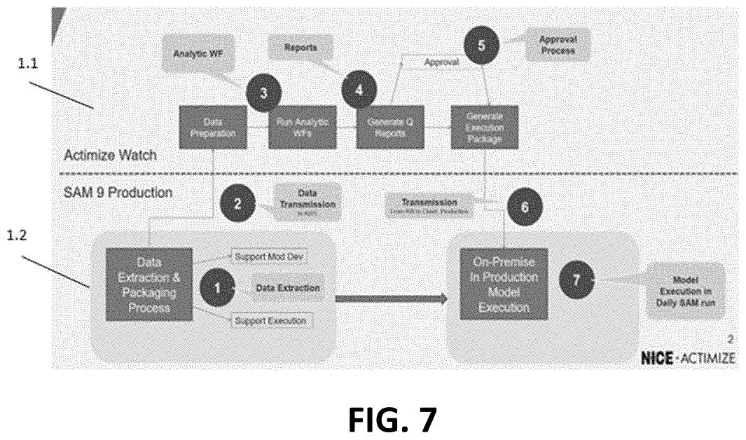

Below a user summary is provided of a new approach developed by Applicant NICE Actimize of NICE Ltd. (Israel), leveraging the power of advanced Machine Learning, to produce finer, more targeted segmentations and allow for the tuning of rules thresholds. This is referred to as the Segmentation model in the remainder of this document. FIG. 7 provides a schematic of the Actimize Watch Analytic & Execution Process. The methods of FIGS. 2-6 are used for AML-SAM.

1.1: ActimizeWatch for AML-SAM is a cloud-based managed analytics service, which provides continuous monitoring and model optimizations, without utilizing on-premise resources at the financial institution. ActimizeWatch provides on-premise AML-SAM installations with advanced analytics-based monitoring, using machine learning for enhanced accuracy, extended coverage and efficiency. The ActimizeWatch team continuously monitors money laundering and financial crime model performance They use their anti-money laundering (AML) and machine learning expertise to optimize Actimize anti-money laundering models when needed, with minimal impact to on-premise resources at the financial institution Financial institutions extract data from their AML-SAM on-premise production environment, and send the data securely to the Actimize X-Sight cloud on Amazon Web Services (AWS), with all personally identifiable information (PII) anonymized. The ActimizeWatch team uses the data to develop optimized segmentation groupings, and tuning thresholds per segment. The enhanced models are sent back to the client for incorporation in their on-premise environment. The ActimizeWatch team provide reports documenting model features and thresholds, as well as the chosen algorithms and why they have been chosen. These can be shared with regulatory bodies as part of the model governance process. The ActimizeWatch platform includes dashboards which provide a visual analytical tool both for developing models and for presenting results. In addition, financial institutions have access to ongoing monthly updates on analytics performance

1.2: AML-SAM provides enhanced leveraging for managed services with advanced analytics capabilities for enhanced accuracy, extended coverage, efficiency and the capabilities to build and deploy advanced segmentation models and optimized thresholds.

Advanced Segmentation: Traditional segmentation creates business segments based on static attributes. Advanced segmentation uses machine learning to sub-divide business segmentation customers into homogenous groups, correlated to risk. Thresholds can then be set per segment or also known as the population group, leading to improved detection accuracy.

Tuning Optimization: The increased number of segments produced by advanced segmentation could result in increased tuning effort to set up segment-specific thresholds. Tuning optimization on the cloud uses machine learning and evaluates multiple simulation iterations to develop optimum thresholds for each segment. It also uses machine learning algorithms to drive down false-positives. This enables on-going tuning with minimal client effort, and without the need for a separate IT environment.

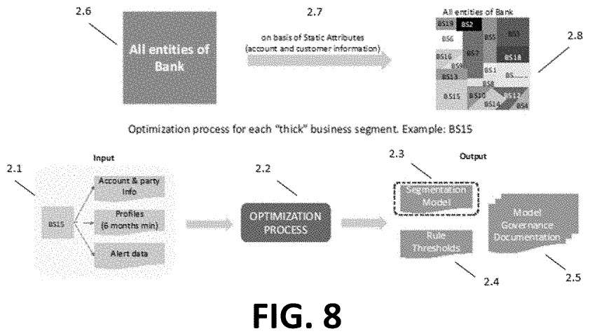

The Segmentation model's overall purpose is to improve the accuracy of suspicious activity alerts by reducing false positives for each business segment and combined. This is achieved by segmenting the entities first into logical business segments using static data (e.g. Account type) and further segmenting these business segments into behavioral homogeneous clusters using transaction data (e.g. number of transactions) in order to allow for customized rule thresholds for each cluster to more accurately determine suspicious activities. FIG. 8 provides a schematic of the new Segmentation model.

2.1: example of typical input to the cluster analysis machine learning process. In this particular example, business segment 15 (BS15) is a business segment data resulted from applying certain business rules of the bank on the entire data. Each such segment can be represented as account & party, list of profiles (aggregated financial data over 6 months) and alert data.

2.2: the process of clustering of business segmented data into clusters.

2.3: specific cluster (possibly using the algorithms of FIGS. 2-6)

2.4: specific rules with thresholds applying on a cluster (2.3)

2.5: process of model governance including documentation.

2.6, 2.7, 2.8 are the visual representation of the process 2.1, 2.2, 2.3, 2.4.

### Practical Implementation—Model Objective and Use

The objective of the Segmentation model is to optimize the thresholds for the rules, that are part of Nice Actimize's SAM 9 solution for identifying suspicious activities. The SAM 9 process may use the methods of FIGS. 2-6. A Segmentation model divides the target population (or business segment) into clusters or segments. The final clusters are used in tuning of the threshold values of the rules specific to the business segment. The threshold value is tuned for each cluster within the business segment. Clusters are used in the optimization tuning process, to determine the rule thresholds with the objective of reducing the false positive rate. This document provides a user summary of the Segmentation model and includes overviews of the following:

Segmentation process

Assumptions and limitations of the segmentation model

Inputs needed for Model-fitting (Scoring)

Outputs

Model Use: This model is designed to be used only in tuning AML Rule thresholds as part of the NICE Actimize Suspicious Alert Monitoring (SAM) process.

### Practical Implementation—Segmentation Process

The segmentation process begins with the development of business level segments that are driven by historic bank specific experience coupled with the bank's expert-judgement. These business segments are then further refined into statistical clusters for more accurate tuning of the rule thresholds. This process is summarized below:

Step 1: Data Extraction. The first step in the segmentation process is the extraction of the following type of data:

Static Data (Account and Customer information):
Used for initial business segmentation
Includes all variables fields except for Personal Identifiable Information (PII) fields, such as name and ID.
Borderline PII such as state or ZIP can be included or excluded.
Keys are extracted but are scrambled as they may contain PII

Profile Data
Used for segmentation based on actual activity (spectral clustering as in FIGS. 2-6 above).
All suspicious activity monitoring (SAM) profiles are extracted but will be subject to analysis to determine relevance.
Daily and weekly profiles are available as well as new measures (median, min, max, etc.)

Issue and Alert Data:
Used for part of Segmentation model validation (other measures are also used)
Also used during tuning to compare test issues to production issues

Data for all entities qualifying the inclusion criteria like minimum months on books (or tenure) and minimum months of activity (non-dormant) are selected for the model. No sampling is applied.

Step 2: Business Segmentation. Working with the Bank, NICE Actimize assists with the development of the High Level business segmentation which is typically based on the bank's perceived risk and monitoring requirements. Several tools are used to accelerate the attribute selection process, and these include:

Risk Correlation Analysis

Dynamic Dashboard

The process is performed for both Accounts and Parties.

Step 3: Machine Learning (Spectral Clustering) Segmentation. Using unsupervised machine learning, specifically spectral clustering of high dimensional data with sparse representation, each business segment is further divided into finer clusters to allow for more targeted rule assignment. Multiple features (profile components) are used to determine the clusters and can be different for each business segment. In order to account for “new” and “dormant” entities, special clusters are created within each business segment group.

### Practical Implementation—Assumptions and Limitations of the Segmentation Model

Like any statistical model, the Segmentation model has its own set of limitations and assumptions. As a user of the Segmentation model, it is important to understand these limitations and assumptions.

Model assumptions:
Numeric Features: Data attributes (i.e. Features) are numeric (both discrete and continuous) features having aggregated. statistics for volume and value of the underlying transactions
Standardization: Scale of each Feature is typically the same (i.e. the unit of measurement is the same for each Feature so that they are comparable). So, the implication is that the new data can be standardized by using z-scaler so that the data is on one scale.
Spherical Clusters: The clusters formed are spherical in nature, meaning, drawing of clusters in n-dimensional space will create clusters of different size but same shape (spherical). Spherical shaped clusters imply increased homogeneity within a cluster and increased heterogeneity across clusters.

Model limitations: In this section, model limitations related to spectral clustering are stated, and wherever a measure has been taken by NA to mitigate it, has been described as well.
Outliers: spectral clustering algorithm is not robust to outliers in the data. Position of the centroids and therefore, cluster membership could be impacted by the presence of outliers. Outliers are detected based on Mahalanobis distance. For each entity, distance is calculated and based on the distribution of distance and upper bound limits are set to identify the outliers. After the entities are identified, the outliers are excluded from the model training data and are kept separate. After the clustering process, the cluster labels are predicted for outliers by assigning them to their closest cluster centers.
Categorical Features: Typically, spectral clustering is not well suited for categorical/binary features. However, this limitation is not applicable to NA's model because all the Features created are numeric (discrete as well as continuous)
K: Number of clusters (K) must be determined beforehand. Hence, initial centroids, randomly generated, influence the results. In order to mitigate the impact of this limitation, several iterations are performed using different values of K and observing multiple statistical metrics. The model Iteration, with K clusters, that has best performance across the metrics (like SD Distance, Calinski-Harabaz Index, S_Dbw Validity Index and Silhouette Index) is chosen as the final model. In case there is no clear winner between models, the model ith the best SD Distance value is chosen. K associated with this model becomes the final K.
Unsupervised segmentation: This segmentation is not “Supervised”, meaning there is no “Y” or Label variable to compare one cluster with the other. In case of “Supervised” segmentation, the event-rate (or percentage of Y=1s getting covered) definitively distinguishes one segment from the other. However, measures like distance between every 2 clusters, mean square error of each error, distinctive central tendencies of cluster drivers across clusters etc. are the reliable measures to assess the strength of the given clustering.

### Practical Implementation—Inputs for Model-Fitting (Scoring)

Segmentation Models are developed using historical data but need to be implemented on present data for either forecasting (in case of supervised model) or for generating insights for actions (in case of unsupervised model). The Segmentation model built using spectral clustering of high dimensional data via sparse representation is an unsupervised model. Implementation of the segmentation model, conceptually as well as operationally, means classifying each entity as being a member of one of the clusters (or segments). The process of classifying an entity by using the segmentation model is called Model-fitting or Scoring.

Operationally, the tangible output of the segmentation model is a set of following items:
1. List of cluster-drivers, or the Features on the basis of which the clusters or segments were created.
2. Cluster center of each of the final clusters in saved models and configurations.
3. Scored data—essentially, the list of entities (Party/Account) with their segment code (giving the information that which segment an entity belongs to)

A file (usually a text file) having the above two (2) sets of information is called the model configuration file.

So, for Scoring the targeted population (or business segment), the following inputs are required:
1. Data: Input data, having the Features on basis of which the data got statistically divided into clusters. As briefly explained above, these Features are also called as Cluster Drivers.
2. Model: Model configuration file, a resultant of Nice Actimize's model-building or model development process on cloud (AWS environment), having all the cluster-centers.
3. Model-Fitting: A set-up or an automated process for fitting the model (via. Model configuration file) on Input data. The output of executing this automated process will result in classifying each entity into one of the clusters or segments.

### Practical Implementation—Outputs

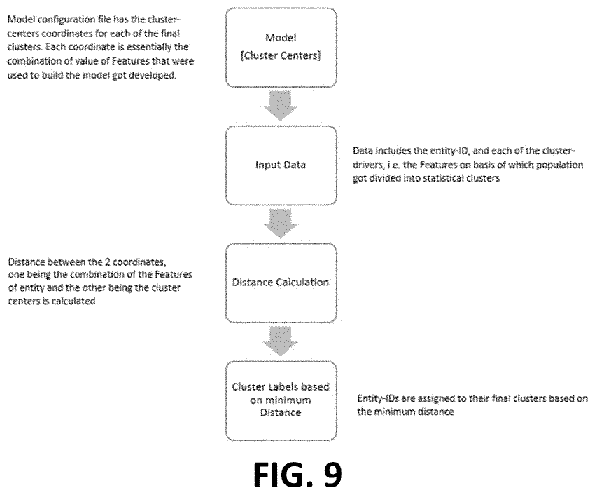

The output generated from the model-building process (a segmentation model in this case) serves as a starting point for the user. Tangible output of the model is typically the Scoring code, which is used to score the in-production and ongoing data. In the case of an unsupervised machine learning segmentation model (spectral clustering analysis), the scoring code comprises of cluster-centers of each cluster (or segment). For each entity-ID in the input data (in-production and/or ongoing data) its distance from each of the clusters is calculated and the entity ID is assigned to the nearest cluster (i.e. the one with the minimum distance). This can be done for all the entities and they are appropriately assigned to their nearest clusters (i.e. segments). FIG. 9 provides further details of this process:

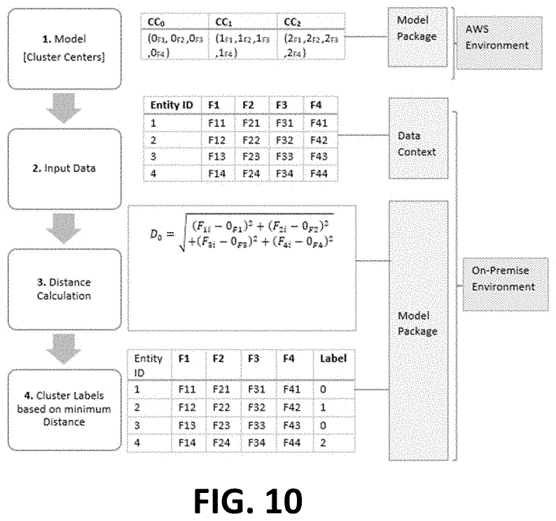

This process is further explained below and in FIG. 10 with the use of an example: If three (3) clusters were created based on 4 features, then the model-configuration file will have a coordinate for each cluster (each coordinate value is a combination of values of the same 4 Features). The disclosure herein provides an automated and refined process to streamline the execution of these steps.

Model: The start point can be the tangible output of the segmentation model, having the cluster-centers. In the example, there are 3 clusters (i.e. segments), having 4 cluster-drivers, essentially, the Features on basis of which the target population can be divided into significantly heterogenous segments. A cluster center is a point having a specific value for each Feature as one coordinate. So, in our example, it is a point in 4-dimensional space. Notation-wise, CCᵢ refers to cluster-i, iFₖ refers to value of Feature k for cluster i. The best segmentation can preferably be achieved (high homogeneity within cluster and high heterogeneity across clusters) with set of these Features, hence, are also called as cluster-drivers.

Input data: This refers to the data having the entities which needs to be classified. For classification of each entity, the set of Features which were finalized as cluster-drivers (in point 1. above) in the segmentation model are needed for each entity-id. For example, for entity-id 1, the values of the 4 Features are F11, F21, F31 and F41.

Distance calculation: In step 1, we get a point in 4-dimension space. So, for 3 clusters formed on basis of 4 Features, there are 3 points in 4-dimension space. In step 2 we get a point in 4-dimension space for each entity-id. For each entity-id, distance between its point is calculated with respect to each cluster-centers. A preferred way to calculate this distance is by applying the formula for calculating distance between 2 points in n-dimensional Euclidean space. For giving an estimate of the volume of calculations involved, if there are 10,000 entity-ids, then 30,000 (=10,000*3) distances are calculated.

Cluster labels: Each entity is labelled as belonging to the cluster, with whose cluster-center its distance is the minimum. In other words, an entity belongs to a cluster 0 if its nearest to cluster-center of cluster 0.

### Practical Implementation—Model Implementation and Execution

Model Implementation: Once the Segmentation Model is developed, it can be deployed in the on-premise Production environment of the client and integrated into the SAM batch process. For implementation, following 2 set of solutions are implemented on-premise:

a) Data Context

b) Model Package

(a) Data Context: This is a highly automated solution mapped for the 2^{nd} step called “Data Input” in the section “Practical Implementation—Inputs for Model-fitting (Scoring)”. Feature creation for the purpose of segmentation involves various steps, like data-extraction, flattening of the data and finally creation of the Feature. The Data Context solution, when included, helps in preparing the data before model implementation. The logic in Data Context achieves following steps:

1. Extraction of data from database

2. Flattening the extracted data to entity-id level

3. Transforming data/Features of the data, and

4. Storing data in files.

This provides the set of logic to explain the course of action to be performed on the data. It is the mapping file which is either in XML or Jason format. The mapping file gives information on data creation approach and different sources to be used for data creation.

The entire process in Data Context, starting from extraction of data from database to final data creation has been explained through an example in the appendix “Data Creation Process”.

(b) Model Package: This is a model-training package mapped for the 3rd step called “Distance calculation” in the section “Practical Implementation—Inputs for Model-fitting (Scoring)”. After the data is transformed and is ready to be used (e.g., through Data Context), the model package can help in performing clustering on business segments.

This model training package is a container generated using RedHat Kubernetes. It stores the output, primarily cluster centers, of the different models. For Example, model package can store the output of X models if the clustering model is run on X business segments.

Model Execution. The model may be executed as follows:

Initialization (manual launch)
All existing entities (parties and accounts) are assigned a new segment
Onetime process to be executed each time a new segmentation model is deployed

Daily Process (part of daily batch)
All new entities are assigned a default segment in their respective business segment group.
Existing entities with updated static data are reassigned if required.

Monthly Process (part of monthly batch)
All entities are reviewed (new and old) and segment changes are assessed.
Switching of segments if sully audited and regulated.
Note: the frequency does not need to be Monthly. It can be Quarterly or even semi-annually. This review frequency is usually the frequency agreed with the client.

Override (ETL process)
Automated segment allocation can be overridden, and specific entities can be forced into designated segments.

### Practical Implementation—Tuning Process on Actimize Watch

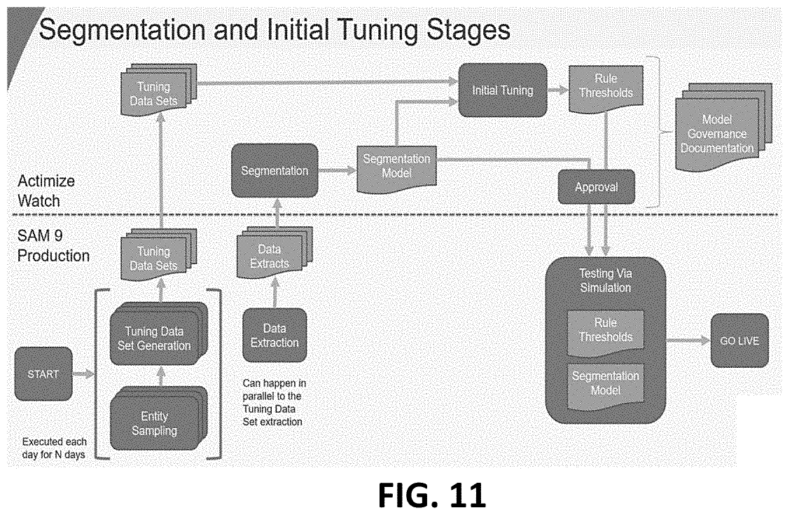

FIG. 11 illustrates segmentation and initial tuning stages. As explained in the segmentation process description above, once the target population has been segmented into statistical clusters, a further step can include tuning the thresholds for each cluster (i.e. segment). The goal of the Tuning Process is to set the Rule thresholds for each segment in a way that minimizes false positives and provides good coverage across the entire target population.

### Results and Comparisons

Four different clustering algorithms can be evaluated, including K-means, K-medoids, Spectral Clustering via sparse approximation, GMM clustering.

The evaluation metrics used are:
SD distance: the average scattering for clusters and total separation between clusters. The lower the value the better.
Calinski-Harbaz: Also known as the Variance Ratio Criterion. The score is defined as ratio between the within-cluster dispersion and the between cluster dispersion. The higher the value the better.
Silhouette: refers to a method of interpretation and validation of consistency within clusters of data. The silhouette value is a measure of how similar an object is to its own cluster (cohesion) compared to other clusters (separation). The silhouette ranges from −1 to +1, where a high value indicates that the object is well matched to its own cluster and poorly matched to neighboring clusters.

Charts were made (not included here) depicting segment visualization according to Principle Components. Top 3 principle components were plotted by cluster. These 3 components explain 48% of variance in the data. One chart represents K-means cluster visualization on Principal Components. Another chart represents K-medoids cluster visualization on Principle Components. Another chart represents spectral clustering via sparse approximation visualization on Principle Components. Still another chart represents GMM cluster visualization on Principle Components.

Spectral clustering via sparse approximation generally provides the best separation of data points along 3 principle components.

Bi-variate plots are created to represent the quality of separation between 3 clusters in a form of similarity matrix according to K-means versus Spectral clustering via sparse approximation. Based on these plots, spectral clustering via sparse approximation outperforms K-means in magnitude.

3D plots can be created to emphasize the performance of segmentation between K-means and Spectral clustering via sparse approximation.

### APPENDIX

### Data Creation Process

Below tables are the illustration of data created at different stages. The final data created is used for clustering process. First the transaction data is extracted from client's database through SAM 9 environment. The data contains transaction activity of entities at different dates for different transaction type.

TABLE A1
Transaction

| | | Transaction | |
|---|---|---|---|
| Account | Date | Type | Value |
| A1 | Jan. 1, 2019 | Loan | 10 |
| Y1 | Jan. 1, 2019 | Credit_Card | 9 |
| Z1 | Jan. 1, 2019 | ATM_Wthd | 2 |
| Y1 | Jan. 1, 2019 | Loan | 5 |
| Z1 | Feb. 1, 2019 | Credit_Card | 6 |
| Y1 | Jan. 1, 2019 | Credit_Card | 7 |
| Z1 | Feb. 1, 2019 | ATM_Wthd | 1 |

Next Summary data is created from the transaction data. Types of Features used for Feature creation are value(amount) and volume. Summary data is prepared for different time frames i.e. daily, weekly and monthly. Below is the summary data created at daily level.

TABLE A2
Summary

| | | Transaction | | | | |
|---|---|---|---|---|---|---|
| Account | Date | Type | Value_sum | Value_avg | Value_max | Volumn_sum |
| A1 | Jan. 1, 2019 | Loan | 10 | 10 | 10 | 1 |
| Y1 | Jan. 1, 2019 | Credit_Card | 16 | 8 | 9 | 2 |
| Y1 | Jan. 1, 2019 | Loan | 5 | 5 | 5 | 1 |
| Z1 | Jan. 1, 2019 | ATM_Wthd | 2 | 2 | 2 | 1 |
| Z1 | Feb. 1, 2019 | ATM_Wthd | 1 | 1 | 1 | 1 |
| Z1 | Feb. 1, 2019 | Credit_Card | 6 | 6 | 6 | 1 |

Profile data is resultant of summary data and is defined at entity and transaction type/transaction group level. The Features of profile data are obtained by grouping the derived Features of summary data.

TABLE A3
Profile

| | | Transaction | | | | |
|---|---|---|---|---|---|---|
| Account | Date | Type | Value_sum | Value_avg | Value_max | Volumn_sum |
| A1 | Jan. 1, 2019 | Loan | 10 | 10 | 10 | 1 |
| Y1 | Jan. 1, 2019 | Credit_Card | 16 | 8 | 9 | 2 |
| Y1 | Jan. 1, 2019 | Loan | 5 | 5 | 5 | 1 |
| Z1 | Jan. 1, 2019 | ATM_Wthd | 2 | 2 | 2 | 1 |
| Z1 | Feb. 1, 2019 | ATM_Wthd | 1 | 1 | 1 | 1 |
| Z1 | Feb. 1, 2019 | Credit_Card | 6 | 6 | 6 | 1 |

Once the profile data is created it is further flattened to form the final table for clustering by transposing the rows into columns such that each entity has unique records.

TABLE A4
Flattened

| | Value_sum_{—} | Value_sum_{—} | Value_avg_{—} | Value_max_{—} | Volumn_sum_{—} | Value_sum_{—} |
|---|---|---|---|---|---|---|
| Account | sum_loan | avg_loan | avg_loan | avg_loan | avg_loan | sum_Credit_Card |
| A1 | 10 | 10 | 10 | 10 | 1 | 0 |
| Y1 | 5 | 5 | 5 | 5 | 1 | 16 |
| Z1 | 0 | 0 | 0 | 0 | 0 | 6 |

| | Value_sum_{—} | Value_avg_{—} | Value_max_{—} | Volumn_sum_{—} | |
|---|---|---|---|---|---|
| Account | avg_Credit_Card | avg_Credit_Card | avg_Credit_Card | avg_Credit_Card | . . . |
| A1 | 0 | 0 | 0 | 0 | . . . |
| Y1 | 16 | 8 | 9 | 2 | . . . |
| Z1 | 6 | 6 | 6 | 1 | . . . |

The flattened daily, weekly and monthly profile data are joined by entity id to form the final table for clustering process.

TABLE A5
Combined Flattened Tables

| Account | Value_sum_sum_loan_daily | . . . | Value_avg_avg_loan_monthly | . . . | Volumn_sum_avg_loan_weekly | . . . |
|---|---|---|---|---|---|---|
| A1 | 10 | . . . | . . . | . . . | . . . | . . . |
| Y1 | 5 | . . . | . . . | . . . | . . . | . . . |
| Z1 | 0 | . . . | . . . | . . . | . . . | . . . |

| Account | Value_sum_avg_Credit_Card_daily | . . . | Value_max_avg_Credit_Card_monthly | . . . |
|---|---|---|---|---|
| A1 | 0 | . . . | . . . | . . . |
| Y1 | 16 | . . . | . . . | . . . |
| Z1 | 6 | . . . | . . . | . . . |

Then the data are stored in AWS storage environment.

Some embodiments of the present invention are defined by the following clauses:

Clause 1 defines a method for clustering financial data, the method comprising:

obtaining, by a computer system comprising one or more computer processors and a computer storage, a dataset X of vectors comprising financial data, wherein in the dataset X, at least one vector is defined by D coordinates where D is an integer greater than one;

obtaining by the computer system, from the dataset X, a dataset Y of vectors, wherein at least one vector in the dataset Y is obtained using a projection, performed by the computer system, of a plurality of vectors S of the dataset X into a linear subspace of R^{D} of a dimension d less than D;

constructing, by the computer system, a similarity matrix on the dataset Y; and

performing, by the computer system, spectral clustering on the similarity matrix to define one or more clusters in the dataset X.

2. The method of clause 1 wherein the dimension d is less than the number of vectors in the plurality of vectors S.

3. The method of any preceding clause wherein the dimension d is less than a dimension of a vector space spanned by the plurality of vectors S.

4. The method of any preceding clause further comprising, for each vector y in the dataset Y, determining coefficients of a representation of the vector y in terms of one or more vectors other than y of the dataset Y;

wherein constructing the similarity matrix comprises determining a similarity between any two vectors in the dataset Y based on similarity of the corresponding coefficients.

5. The method of clause 4, wherein the coefficients are determined by solving an optimization problem to increase the sparsity of the coefficients while minimizing distances between the vectors y and their representations.

6. The method of clause 5, wherein the distances between the vectors y and their representations are weighted with weights that are, for each vector y, values of a decreasing function of an error present in obtaining the vector y from the dataset X.

7. The method of any one of clauses 4 to 6, wherein for each vector y in the dataset Y, the coefficients are determined using an error function which comprises a term for each vector yᵢ other than y in the dataset Y, the term having a corresponding weight in the error function, the weight being a decreasing function of a reconstruction error in reconstructing the vector y, from a projection of the corresponding vector in the dataset X.

8. The method of any preceding clause wherein the similarity is Sparsity Induced Similarity (SIS) or Cosine Similarity (COS).

9. The method of claim 1, wherein the method comprises obtaining said projection by the computer system, and obtaining said projection comprises performing a plurality of iterations, wherein each iteration comprises determining a mapping of the set S into the linear subspace of R^{D};

wherein at least one iteration uses weights obtained from values of a decreasing function of errors of a previous iteration, wherein each error is associated with a vector in the set S, each error being a mapping error in the mapping of the associated vector in the previous iteration.

10. The method of clause 9, wherein in each iteration, the mapping is linear.

11. The method of clause 9 or 10, wherein the decreasing function is one of:

a(x)=1/x

a(x) is a strictly decreasing linear function on an interval of non-negative integers, and is zero outside of the interval.

12. The method of clause 9, 10, or 11, wherein each iteration other than an initial iteration, uses the weights obtained from values of the decreasing function of the errors of the previous iteration.

13. The method of any one of clauses 7 to 12, wherein in said at least one iteration, determining the mapping comprises solving, by the computer system, an optimization problem to minimize a weighted sum of mapping errors weighted by the weights obtained from the values of the decreasing function of the errors of the previous iteration.

14. The method of any preceding clause, wherein the dataset X is a financial dataset, and the method further comprising using the clusters in the dataset X to detect money laundering.

15. The method of any preceding clause, wherein each vector in the dataset Y is obtained using a projection, performed by the computer system, of a corresponding plurality of vectors of the dataset X into a linear subspace of R^{D} of a dimension d less than D.

The invention also includes computer systems configured to perform the methods described herein, and computer readable media comprising computer instructions executable by computer systems' processors to perform the methods described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A method for clustering financial data, the method comprising:
obtaining, by a computer system comprising one or more computer processors and a computer storage, a dataset X of vectors comprising financial data, wherein in the dataset X, at least one vector is defined by D coordinates where D is an integer greater than one;
obtaining by the computer system, from the dataset X, a dataset Y of vectors, wherein at least one vector in the dataset Y is obtained using a projection, performed by the computer system, of a plurality of vectors S of the dataset X into a linear subspace of R^{D} of a dimension d less than D;
constructing, by the computer system, a similarity matrix on the dataset Y; and
performing, by the computer system, spectral clustering on the similarity matrix to define one or more clusters in the dataset X.

2. The method of claim 1 wherein the dimension d is less than a dimension of a vector space spanned by the plurality of vectors S.

3. The method of claim 1 further comprising, for each vector y in the dataset Y, determining coefficients of a representation of the vector y in terms of one or more vectors other than y of the dataset Y;
wherein constructing the similarity matrix comprises determining a similarity between any two vectors in the dataset Y based on similarity of the corresponding coefficients.

4. The method of claim 3, wherein the coefficients are determined by solving an optimization problem to increase the sparsity of the coefficients while minimizing distances between the vectors y and their representations.

5. The method of claim 3, wherein the distances between the vectors y and their representations are weighted with weights that are, for each vector y, values of a decreasing function of an error present in obtaining the vector y from the dataset X.

6. The method of claim 3, wherein for each vector y in the dataset Y, the coefficients are determined using an error function which comprises a term for each vector yᵢ other than y in the dataset Y, the term having a corresponding weight in the error function, the weight being a decreasing function of a reconstruction error in reconstructing the vector yᵢ from a projection of the corresponding vector in the dataset X.

7. The method of claim 1 wherein the similarity is Sparsity Induced Similarity (SIS) or Cosine Similarity (COS).

8. The method of claim 1, wherein the method comprises obtaining said projection by the computer system, and obtaining said projection comprises performing a plurality of iterations, wherein each iteration comprises determining a mapping of the set S into the linear subspace of R^{D};
wherein at least one iteration uses weights obtained from values of a decreasing function of errors of a previous iteration, wherein each error is associated with a vector in the set S, each error being a mapping error in the mapping of the associated vector in the previous iteration.

9. The method of claim 8, wherein the decreasing function is one of:
a(x)=1/x
a(x) is a strictly decreasing linear function on an interval of non-negative integers, and is zero outside of the interval.

10. The method of claim 8 wherein each iteration other than an initial iteration, uses the weights obtained from values of the decreasing function of the errors of the previous iteration.

11. The method of claim 8 wherein in said at least one iteration, determining the mapping comprises solving, by the computer system, an optimization problem to minimize a weighted sum of mapping errors weighted by the weights obtained from the values of the decreasing function of the errors of the previous iteration.

12. The method of claim 1 further comprising using the clusters in the data set X to detect money laundering.

13. The method of claim 1 wherein each vector in the dataset Y is obtained using a projection, performed by the computer system, of a corresponding plurality of vectors of the dataset X into a linear subspace of R^{D} of a dimension d less than D.

14. A computer system comprising one or more computer processors and a computer storage and configured to cluster financial data, by performing operations of:
obtaining a dataset X of vectors comprising financial data, wherein in the dataset X, at least one vector is defined by D coordinates where D is an integer greater than one;
obtaining, from the dataset X, a dataset Y of vectors, wherein at least one vector in the dataset Y is obtained using a projection, performed by the computer system, of a plurality of vectors S of the dataset X into a linear subspace of R^{D} of a dimension d less than D;
constructing a similarity matrix on the set Y; and
performing spectral clustering on the similarity matrix to define one or more clusters in the dataset X.

15. The computer system of claim 14 wherein the dimension d is less than the number of vectors in the plurality of vectors S.

16. The computer system of claim 14 wherein the method further comprises, for each vector y in the dataset Y, determining coefficients of a representation of the vector y in terms of one or more vectors other than y of the dataset Y; and
wherein constructing the similarity matrix comprises determining a similarity between any two vectors in the dataset Y based on similarity of the corresponding coefficients.

17. The computer system of claim 16 wherein the distances between the vectors y and their representations are weighted with weights that are, for each vector y, a decreasing function of an error present in obtaining the vector y from the dataset X.

18. The computer system of claim 17, wherein the computer system is configured to determine the coefficients by solving an optimization problem increasing the sparsity of the coefficients while minimizing distances between the vectors y and their representations ŷ.

19. The computer system of claim 14, wherein the computer system is configured to obtain said projection in performing a plurality of iterations, wherein each iteration comprises determining a mapping of the set S into the linear subspace of R^{D};
wherein at least one iteration uses weights obtained from values of a decreasing function of errors of a previous iteration, wherein each error is associated with a vector in the set S, each error being a mapping error in the mapping of the associated vector in the previous iteration.

20. A computer readable medium comprising one or more computer instructions to configure a computer system comprising one or more computer processors executing the instructions and comprising a computer storage to perform operations of:
obtaining a dataset X of vectors, wherein in the dataset X, at least one vector is defined by D coordinates where D is an integer greater than one;
obtaining, from the dataset X, a dataset Y of vectors, wherein at least one vector in the dataset Y is obtained using a projection, performed by the computer system, of a plurality of vectors S of the dataset X into a linear subspace of R^{D} of a dimension d less than D;
constructing a similarity matrix on the set Y; and
performing spectral clustering on the similarity matrix to define one or more clusters in the dataset X.
